(19) United States
(12) Patent Application Publication
(10) Pub. No.: US 2024/0360995 A1
(43) Pub. Date: Oct. 31, 2024

(54) COMBUSTOR

(71) Applicant: KABUSHIKI KAISHA TOYOTA JIDOSHOKKI, Kariya-shi, Aichi (JP)

(72) Inventors: Hideaki SUZUKI, Kariya-shi, Aichi (JP); Hiroyasu KAWAUCHI, Kariya-shi, Aichi (JP); Yoshitaka TAKEUCHI, Kariya-shi, Aichi (JP)

(73) Assignee: KABUSHIKI KAISHA TOYOTA JIDOSHOKKI, Kariya-shi, Aichi (JP)

(21) Appl. No.: 18/291,769

(22) PCT Filed: May 24, 2022
(86) PCT No.: PCT/JP2022/021296

§ 371 Date: Jan. 24, 2024

(30) Foreign Application Priority Data
Jul. 26, 2021 (JP) 2021-121326

(51) Int. Cl. F23D 14/24; B01J 19/00; C01B 3/04; F23Q 3/00

(52) U.S. Cl. CPC F23D 14/24; B01J 19/0013; C01B 3/047; F23Q 3/008; B01J 2219/00157

(57) ABSTRACT

A combustor includes a combustion pipe, a gas introduction pipe, and an igniter. The gas introduction pipe is connected at one end of the gas introduction pipe to the combustion pipe, and the one end has a gas outlet through which ammonia and oxidized gas flow to the combustion pipe. The gas introduction pipe protrudes toward an inside of the combustion pipe through an insertion hole of the combustion pipe in a tangential direction to an inner peripheral surface of the combustion pipe so that the gas outlet is accommodated in the combustion pipe. The gas introduction pipe has a cross-sectional area that is defined so that mixed gas of the ammonia and the oxidized gas flows to the combustion pipe through the gas outlet at a flow velocity of 3 m/s to 25 m/s relative to a flow rate of the mixed gas.

### TECHNICAL FIELD

The present invention is related to a combustor.

### BACKGROUND ART

Patent Literature 1 describes a tubular flame burner, which is known as a combustor, for example. The tubular flame burner described in Patent Literature 1 includes: a combustion pipe having a cylindrical shape, being closed at the proximal end of the combustion pipe and opened at the distal end of the combustion pipe, and having a combustion chamber; a plurality of flat flow passages through which combustion air is supplied to the combustion chamber; and a plurality of fuel gas supply passages connected to the plurality of flat flow passages and through which fuel gas is supplied to the combustion chamber. The combustion pipe has a plurality of slits that is opened on a side surface of the proximal end of the combustion pipe along the axial direction of the combustion chamber. The flat flow passages are connected to the slits and widened in the width direction corresponding to the axial direction of the combustion chamber. The slits are formed so that the combustion air and the fuel gas are mixed and injected in a tangential direction to the inner surface of the combustion chamber. When the combustion air and the fuel gas are mixed and injected from the slits in the tangential direction to the inner surface of the combustion chamber, the mixed gas swirls along the inner surface of the combustion chamber and the fuel gas burns and forms a swirling flame (tubular flame).

### CITATION LIST

### Patent Literature

Patent Literature 1: Japanese Patent Application Publication No. 2019-100678

### SUMMARY OF THE INVENTION

### Technical Problem

The conventional technology previously described allows an ideal swirl flow of the mixed gas of the fuel gas and the combustion air (oxidized gas) to be generated in the combustion chamber, so that the fuel gas easily burns. However, the combustion pipe needs to have fine slits that serve as a gas introduction portion introducing the fuel gas and the combustion air to the combustion chamber. This complicates the structure of the gas introduction portion, thereby complicates forming of the gas introduction portion.

An object of the present invention is directed to providing a combustor that includes a gas introduction portion introducing fuel gas and oxidized gas to a combustion pipe, the gas introduction portion having a simple structure for facile forming, the gas introduction portion being configured to generate a swirl flow of the fuel gas and the oxidized gas in the combustion pipe.

### Solution to Problem

A combustor according to an embodiment of the present invention includes: a combustion pipe having a cylindrical shape, the combustion pipe being opened at one end of the combustion pipe and fixed to a closure wall at the other end of the combustion pipe; a gas introduction pipe attached to the combustion pipe and introducing fuel gas and oxidized gas to the combustion pipe; and an igniter attached to the closure wall and configured to ignite the fuel gas introduced by the gas introduction pipe to the combustion pipe, wherein the combustion pipe has an insertion hole into which the gas introduction pipe is inserted, the gas introduction pipe is connected at one end of the gas introduction pipe to the combustion pipe, and the one end has a gas outlet through which the fuel gas and the oxidized gas flow to the combustion pipe, and the gas introduction pipe protrudes toward an inside of the combustion pipe through the insertion hole in a tangential direction to an inner peripheral surface of the combustion pipe so that the gas outlet is accommodated in the combustion pipe.

In such a combustor, the fuel gas and the oxidized gas are introduced by the gas introduction pipe to the cylindrical combustion pipe, and the mixed gas of the fuel gas and the oxidized gas flows through the combustion pipe toward the closure wall. The fuel gas in the mixed gas is ignited by the igniter, and burns to generate combustion gas. The combustion gas flows toward the open end of the combustion pipe. The gas introduction pipe protrudes toward the inside of the combustion pipe through the insertion hole in the tangential direction to the inner peripheral surface of the combustion pipe so that the gas outlet is accommodated in the combustion pipe. The fuel gas and the oxidized gas are introduced to the combustion pipe and a swirl flow (tubular flow) of the fuel gas and the oxidized gas is generated in the combustion pipe. This allows the fuel gas to ignite while swirling so as to form a tubular flame. Furthermore, for attachment of the gas introduction pipe to the combustion pipe, the combustion pipe may be simply drilled to form the insertion hole so that the gas introduction pipe is inserted into the insertion hole. This simplifies the structure of the gas introduction portion introducing the fuel gas and the oxidized gas to the combustion pipe, thereby facilitating forming of the gas introduction portion.

The gas introduction pipe may have a cross-sectional area that is defined so that mixed gas of the fuel gas and the oxidized gas flows to the combustion pipe through the gas outlet at a flow velocity of 3 m/s to 25 m/s relative to a flow rate of the mixed gas. This widens the combustible range of the fuel gas relative to the excess ratio of the oxidized gas, so that the fuel gas stably and easily burns.

The gas introduction pipe may have a circular shape in cross-section, and a ratio of an inner diameter of the gas introduction pipe to an inner diameter of the combustion pipe may be 0.30 to 0.45. This further widens the combustible range of the fuel gas relative to the excess ratio of the oxidized gas when the flow rate of the fuel gas supplied to the combustion pipe is particularly high. Accordingly, the fuel gas more stably and easily burns.

The combustion pipe may have a main body and a tapered portion that tapers from the main body toward the closure wall. This configuration improves the symmetry of the flow velocity of the mixed gas with respect to the axial direction of the combustion pipe in the vicinity of the igniter. Accordingly, the fuel gas more stably and easily burns.

The main body may have the insertion hole, and a difference between an outer radius of a proximal end of the tapered portion and an outer radius of a distal end of the tapered portion may be equal to or smaller than an inner radius of the main body. This further widens the combustible range of the fuel gas relative to the excess ratio of the oxidized gas when the flow rate of the fuel gas supplied to the combustion pipe is particularly high. Accordingly, the fuel gas further stably and easily burns.

### Advantageous Effects of the Invention

According to the present invention, a combustor includes a gas introduction portion introducing fuel gas and oxidized gas to a combustion pipe, the gas introduction portion having a simple structure for facile forming, the gas introduction portion being configured to generate a swirl flow of the fuel gas and the oxidized gas in the combustion pipe.

### BRIEF DESCRIPTION OF THE DRAWINGS

FIG. 1 is a schematic configuration diagram of a reforming system including a combustor according to a first embodiment of the present invention.

FIG. 2 is a perspective view of the combustor illustrated in FIG. 1.

FIG. 3 is a cross-sectional view of the combustor illustrated in FIG. 2.

FIG. 4 is a cross-sectional view of the combustor of FIG. 3, taken along the line IV-IV.

FIG. 5 is a perspective view of a combustor as a comparative example.

FIG. 6 is a cross-sectional view of the combustor illustrated in FIG. 5.

FIG. 7 is a graph showing a comparison of the combustible range of ammonia gas relative to an excess air ratio λ in the combustor illustrated in FIG. 4.

FIG. 8 is a cross-sectional view of a combustor according to a second embodiment of the present invention.

FIG. 9 is a graph showing a comparison of the combustible range of ammonia gas relative to an excess air ratio A in the combustor illustrated in FIG. 8.

FIG. 10 is a cross-sectional view of a combustor according to a third embodiment of the present invention.

FIG. 11 is a graph showing a comparison of the combustible range of ammonia gas relative to an excess air ratio A in the combustor illustrated in FIG. 10.

FIG. 12 is a cross-sectional view of a modification of the combustor illustrated in FIG. 3.

### DESCRIPTION OF EMBODIMENTS

The following will describe embodiments of the present invention in detail with reference to figures. Identical or equivalent elements are denoted with the same symbols in the figures and redundant explanations are omitted.

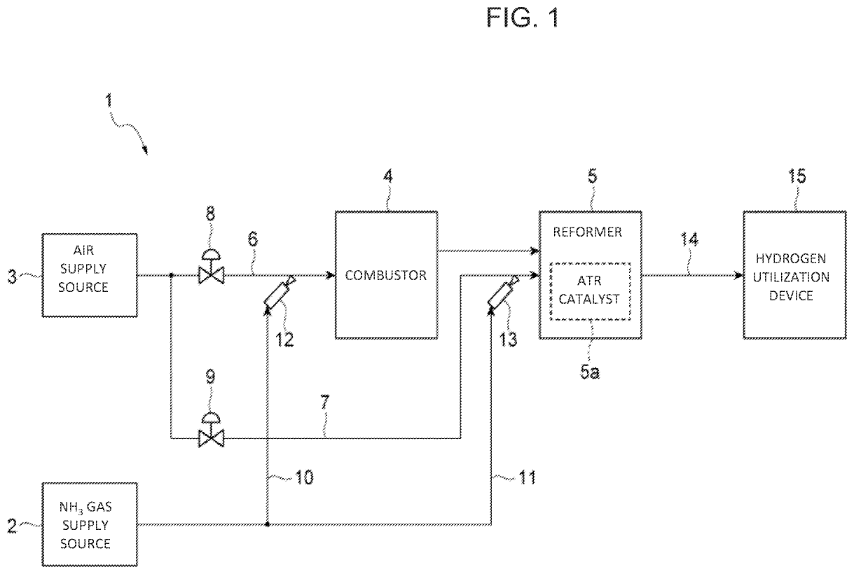

FIG. 1 is a schematic configuration diagram of a reforming system including a combustor according to a first embodiment of the present invention. In FIG. 1, a reforming system 1 includes an ammonia gas supply source 2, an air supply source 3, a combustor 4 according to the present embodiment, and a reformer 5.

The ammonia gas supply source 2 generates ammonia gas (NH₃ gas) serving as fuel gas. Although not particularly illustrated, the ammonia gas supply source 2 includes an ammonia tank for storing liquid ammonia, and a vaporizer for vaporizing the liquid ammonia into ammonia gas.

The air supply source 3 delivers air serving as oxidized gas. The air supply source 3 is an air blower, for example.

The combustor 4 combusts the ammonia gas generated by the ammonia gas supply source 2 to generate high-temperature combustion gas. The combustor 4 will be described later in detail.

The reformer 5 is connected to the combustor 4. The reformer 5 is connected to the combustor 4 directly or via a connecting pipe. The reformer 5 is configured to reform ammonia gas into reformed gas containing hydrogen by using heat generated by combustion of ammonia gas.

The reformer 5 includes an ATR catalyst 5a. The ATR catalyst 5a serves as an autothermal reforming catalytic device that combusts ammonia gas with the heat of the combustion gas generated by the combustor 4 and reforms ammonia gas by decomposing ammonia gas into hydrogen with the combustion heat (self-heat) of the ammonia gas. The ATR catalyst 5a has a honeycomb structure, for example.

For example, the ATR catalyst 5a combusts the ammonia gas in a temperature range of approximately 200° C. to 400° C. and reforms the ammonia gas in a range of temperature (e.g., approximately 250° C. to 500° C.) higher than the combustion temperature of the ammonia gas. Examples of the ATR catalyst 5a include a cobalt catalyst, a rhodium catalyst, a ruthenium catalyst, and a palladium catalyst.

Instead of the ATR catalyst 5a, the reformer 5 may include a combustion catalyst for combusting the ammonia gas and a reformer catalyst for decomposing the ammonia gas into hydrogen separately.

The reforming system 1 includes air flow passages 6, 7, throttle valves 8, 9, ammonia gas passages 10, 11, and injectors 12, 13.

The air supply source 3 is connected to the combustor 4 via the air flow passage 6. The air flow passage 6 is a passage through which the air generated in the air supply source 3 flows toward the combustor 4. The air supply source 3 is connected to the reformer 5 via the air flow passage 7. The air flow passage 7 is a passage through which the air generated in the air supply source 3 flows toward the reformer 5.

The throttle valve 8 is disposed in the air flow passage 6. The throttle valve 8 is a flow rate control valve for controlling a flow rate of the air supplied to the combustor 4. The throttle valve 9 is disposed in the air flow passage 7. The throttle valve 9 is a flow rate control valve for controlling a flow rate of the air supplied to the reformer 5.

The ammonia gas supply source 2 is connected to the injector 12 via the ammonia gas passage 10. The ammonia gas passage 10 is a passage through which the ammonia gas generated in the ammonia gas supply source 2 flows toward the injector 12. The ammonia gas supply source 2 is connected to the injector 13 via the ammonia gas passage 11. The ammonia gas passage 11 is a passage through which the ammonia gas generated in the ammonia gas supply source 2 flows toward the injector 13.

The injector 12 is a fuel injection valve that is configured to inject the ammonia gas toward the combustor 4. The injector 12 injects the ammonia gas between the throttle valve 8 and the combustor 4 in the air flow passage 6. The ammonia gas and the air flow upstream of the combustor 4 in the air flow passage 6.

The injector 13 is a fuel injection valve that is configured to inject the ammonia gas toward the reformer 5. The injector 13 injects the ammonia gas between the throttle valve 9 and the reformer 5 in the air flow passage 7. The ammonia gas and the air flow upstream of the reformer 5 in the air flow passage 7.

The reformer 5 is connected to a hydrogen utilization device 15 via a reformed gas passage 14. The reformed gas passage 14 is a passage through which the reformed gas generated by the reformer 5 flows toward the hydrogen utilization device 15.

The hydrogen utilization device 15 is a device that utilizes hydrogen contained in the reformed gas. Examples of the hydrogen utilization device 15 include an ammonia engine or an ammonia gas turbine that uses ammonia gas as fuel, and a fuel cell that generates power by a chemical reaction of hydrogen with oxygen in air.

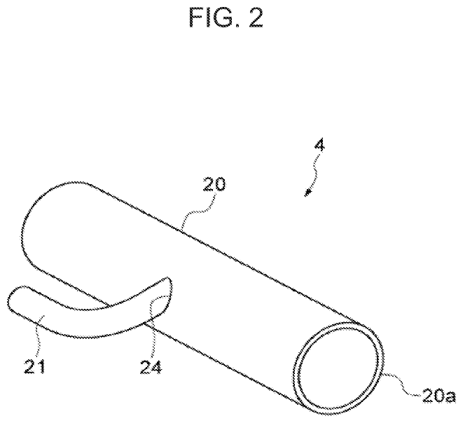

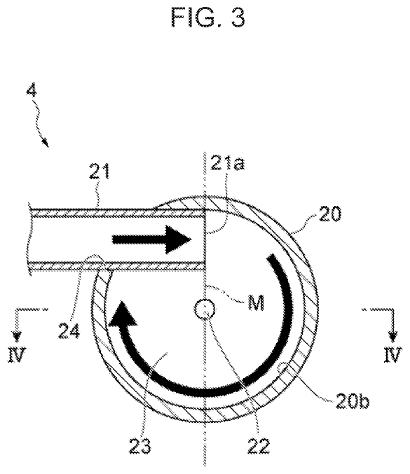

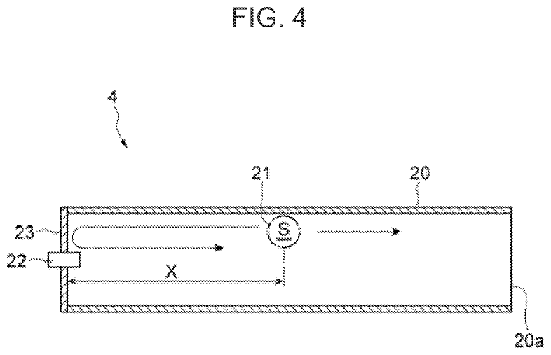

FIG. 2 is a perspective view of the combustor 4. FIG. 3 is a cross-sectional view of the combustor 4. FIG. 4 is a cross-sectional view of the combustor 4 of FIG. 3, taken along the line IV-IV. In FIGS. 2-4, the combustor 4 of this embodiment is a tubular flame burner.

The combustor 4 includes a combustion pipe 20, a gas introduction pipe 21 for introducing ammonia and air to the combustion pipe 20, and a spark plug 22 for igniting the ammonia gas introduced by the gas introduction pipe 21 to the combustion pipe 20.

The combustion pipe 20 and the gas introduction pipe 21 are made of a metallic material, such as stainless steel, which is resistant to ammonia gas corrosion. The combustion pipe 20 and the gas introduction pipe 21 have a cylindrical shape (circular shape in cross-section). The combustion pipe 20 and the gas introduction pipe 21 have a circular shape in cross-section perpendicular to the axial direction of the combustion pipe 20 and the gas introduction pipe 21. The circular shape here includes not only a perfect circular shape but also an elliptical shape.

The combustion pipe 20 is opened at one end of the combustion pipe 20. That is, the one end of the combustion pipe 20 is an open end 20a. The combustion pipe 20 is closed at the other end of the combustion pipe 20. The combustion pipe 20 is fixed, at the other end of the combustion pipe 20, to a closure wall 23 having a circular shape.

The gas introduction pipe 21 is connected at one end of the gas introduction pipe 21 to the combustion pipe 20. That is, the one end of the gas introduction pipe 21 is the end that is connected to the combustion pipe 20. The gas introduction pipe 21 is connected at the other end of the gas introduction pipe 21 to the air flow passage 6. The gas introduction pipe 21 is bent in a substantially L-shape so as to extend along the axial direction of the combustion pipe 20.

The combustion pipe 20 has an insertion hole 24 having a circular shape in cross-section and into which the gas introduction pipe 21 is inserted. The insertion hole 24 is arranged at the center portion of the combustion pipe 20 in the axial direction of the combustion pipe 20. The insertion hole 24 is formed at a position determined so that the gas introduction pipe 21 is inserted into the combustion pipe 20 in the tangential direction to the inner peripheral surface 20b of the combustion pipe 20.

A mixed gas of the ammonia gas and the air flows in the gas introduction pipe 21. The one end of the gas introduction pipe 21 has a gas outlet 21a through which the mixed gas of the ammonia gas and the air flows to the combustion pipe 20. The gas introduction pipe 21 protrudes toward the inside of the combustion pipe 20 through the insertion hole 24 in the tangential direction to the inner peripheral surface 20b of the combustion pipe 20 so that the gas outlet 21a is accommodated in the combustion pipe 20. The tangential direction here includes not only the complete tangential direction but also the substantially tangential direction.

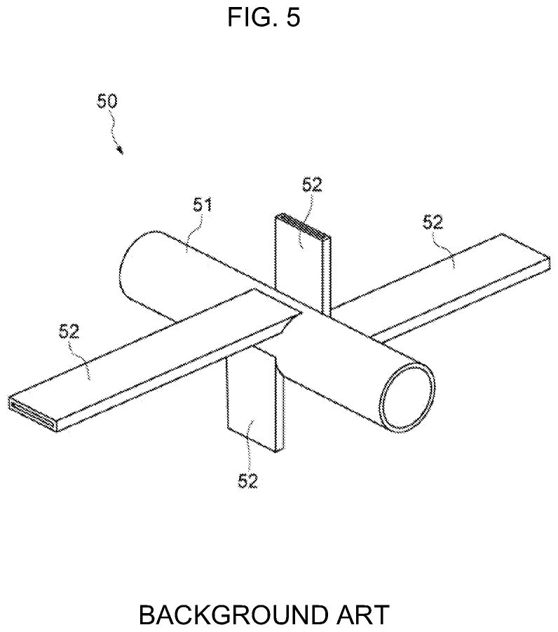

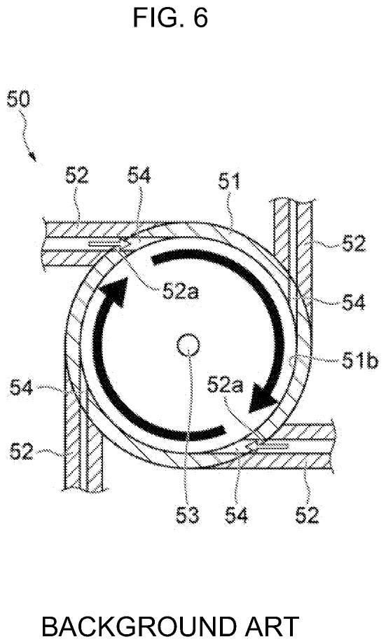

The end face of the one end of the gas introduction pipe 21 defines the gas outlet 21a and is arranged at a position corresponding to the position of an imaginary plane M along the radial direction of the combustion pipe 20 in the combustion pipe 20 (see FIG. 3). Accordingly, the mixed gas of the ammonia gas and the air is introduced to the combustion pipe 20 in the tangential direction to the inner peripheral surface 20b of the combustion pipe 20, so that a swirl flow (tubular flow) of the mixed gas is generated in the combustion pipe 20. Specifically, the mixed gas flowing in the axial direction of the gas introduction pipe 21 along the inner wall surface of the gas introduction pipe 21 flows through the gas outlet 21a and along the inner wall surface of the combustion pipe 20 in the circumferential direction of the combustion pipe 20. This configuration is more likely to cause a swirl flow of the mixed gas, compared with a configuration in which the end surface of the one end of the gas introduction pipe 21 is connected to the outer peripheral surface of the combustion pipe 20 so that the gas outlet 21a of the gas introduction pipe 21 is not accommodated in the combustion pipe 20 (similar to the configurations illustrated in FIGS. 5 and 6, for example).

The gas introduction pipe 21 has a circular shape in cross-section as previously described. The gas introduction pipe 21 has a cross-sectional area S that is defined so that the mixed gas of the ammonia gas and the air flows to the combustion pipe 20 through the gas outlet 21b at a flow velocity (inrush flow velocity) of 3 m/s to 25 m/s relative to a flow rate (L/min) of the mixed gas. The cross-sectional area S of the gas introduction pipe 21 is expressed by the flow rate of the mixed gas/inrush flow velocity of the mixed gas.

The spark plug 22 is attached to the radial center portion of the closure wall 23. The spark plug 22 serves as an igniter configured to ignite the ammonia gas introduced to the combustion pipe 20.

In the combustor 4, the mixed gas of the ammonia gas and the air introduced by the gas introduction pipe 21 to the combustion pipe 20 forms a swirl flow (see FIG. 3). Part of the mixed gas swirls and flows in the combustion pipe 20 toward the closure wall 23 (see FIG. 4). When the mixed gas reaches the vicinity of the closure wall 23, the spark plug 22 ignites the ammonia gas in the mixed gas, so that the ignited ammonia gas forms a tubular flame and generates the combustion gas. The combustion gas flows with the rest of the mixed gas toward the open end 20a of the combustion pipe 20 (see FIG. 4).

The throttle valves 8, 9 and the injectors 12, 13 are opened when the reforming system 1 including the combustor 4 is activated. The air flows through the air flow passages 6, 7 toward the combustor 4 and the reformer 5, and the injectors 12, 13 inject the ammonia gas toward the combustor 4 and the reformer 5. Accordingly, the mixed gas of the ammonia gas and the air is supplied to the combustor 4 and the reformer 5.

In the combustor 4, the mixed gas is introduced by the gas introduction pipe 21 to the combustion pipe 20, and swirls and flows in the combustion pipe 20. When the mixed gas reaches the vicinity of the closure wall 23, the ammonia gas in the mixed gas ignited by the spark plug 22 burns. Specifically, ammonia and oxygen in the air chemically react as the following formula to generate high-temperature combustion gas (exothermic reaction).

NH₃+3/4O₂→1/2N₂+3/2H₂O (A)

The combustion gas flows through the combustion pipe 20 toward the open end 20a and is supplied to the reformer 5. The ATR catalyst 5a of the reformer 5 is heated by the heat of the combustion gas, and the temperature of the ATR catalyst 5a is therefore increased. The spark plug 22 is stopped when the temperature of the ATR catalyst 5a increases to a combustion temperature, and the throttle valve 8 and the injector 12 are closed to stop the supply of the air and the ammonia gas to the combustor 4. Accordingly, the generation of the combustion gas by the combustor 4 is completed.

The ATR catalyst 5a combusts the ammonia gas when the temperature of the ATR catalyst 5a increases to the combustion temperature. This causes the exothermic reaction expressed in the formula (A), so that the self-heat of the ATR catalyst 5a further increases the temperature of the ATR catalyst 5a.

The temperature of the ATR catalyst 5a increases to a reforming temperature, so that the ATR catalyst 5a reforms the ammonia gas. Specifically, ammonia decomposition reaction (endothermic reaction) is caused as the following formula to generate reformed gas containing hydrogen. The reformed gas is supplied to the hydrogen utilization device 15 through the reformed gas passage 14.

NH₃→3/2H₂+1/2N₂ (B)

FIG. 5 is a perspective view of a combustor as a comparative example. FIG. 6 is a cross-sectional view of the combustor illustrated in FIG. 5. In FIGS. 5 and 6, a combustor 50 according to the comparative example includes a combustion pipe 51 that has a cylindrical shape, and is opened at one end of the combustion pipe 51 and closed at the other of the combustion pipe 51, four flat gas introduction members 52 for introducing ammonia and air to the combustion pipe 51, and a spark plug 53 for igniting the ammonia gas introduced to the combustion pipe 51.

The combustion pipe 51 has four slits 54 that are equiangularly spaced from each other along the circumferential direction. The slits 54 extend in the axial direction of the combustion pipe 51. Each of the gas introduction members 52 is fixed to the combustion pipe 51 so that a gas outlet 52a is connected to the slit 54. The gas introduction member 52 cooperates with the slit 54 to introduce the ammonia and the air in the tangential direction to the inner peripheral surface 51b of the combustion pipe 51. This generates an ideal swirl flow of the ammonia and the air.

However, in this comparative example, the four flat gas introduction members 52 form the gas introduction portion for introducing the ammonia gas and the air to the combustion pipe 51. Accordingly, the combustion pipe 51 needs to have four fine slits 54. This complicates the structure of the gas introduction portion, thereby complicates forming of the gas introduction portion. Furthermore, the four gas introduction members 52 respectively extend in four directions in the radial direction of the combustion pipe 51, so that the combustor 50 is increased in size.

In order to solve such a circumstance, in the present embodiment, the ammonia gas and the air are introduced by the gas introduction pipe 21 to the cylindrical combustion pipe 20, and the mixed gas of the ammonia gas and the air flows through the combustion pipe 20 toward the closure wall 23. The ammonia gas in the mixed gas ignited by the spark plug 22 burns to generate combustion gas. The combustion gas flows to the open end of the combustion pipe 20. The gas introduction pipe 21 protrudes toward the inside of the combustion pipe 20 through the insertion hole 24 in the tangential direction to the inner peripheral surface 20b of the combustion pipe 20 so that the gas outlet 21a is accommodated in the combustion pipe 20. The ammonia gas and the air are introduced to the combustion pipe 20 and a swirl flow (tubular flow) of the ammonia gas and the air is therefore generated in the combustion pipe 20. This allows the ammonia gas to ignite while swirling so as to form a tubular flame. Furthermore, for attachment of the gas introduction pipe 21 to the combustion pipe 20, the combustion pipe 20 may be simply drilled to form the insertion hole 24 so that the gas introduction pipe 21 is inserted into the insertion hole 24. This simplifies the structure of the gas introduction portion introducing the ammonia gas and the air to the combustion pipe 20, thereby facilitating forming of the gas introduction portion. Furthermore, the gas introduction pipe 21 is bent so as to extend along the axial direction of the combustion pipe 20 so that the combustor 4 is reduced in size in the radial direction of the combustor 4.

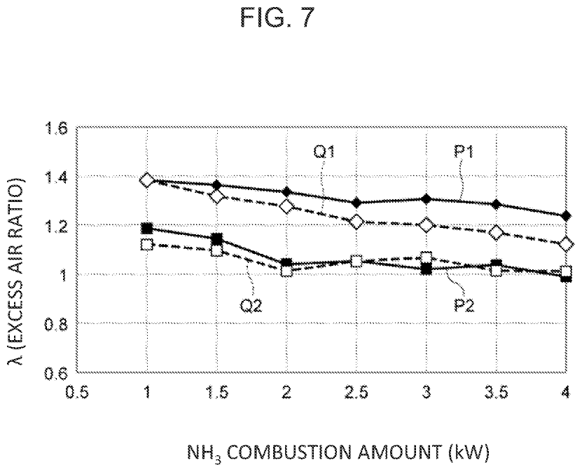

When the ammonia gas and the air are introduced by the gas introduction pipe 21 to the combustion pipe 20, a swirl flow of the mixed gas of the ammonia gas and the air is generated. However, the mixed gas interferes with the gas introduction pipe 21 while swirling in the combustion pipe 20, and therefore may become asymmetric in flow velocity with respect to the axial direction of the combustion pipe 20 in the vicinity of the spark plug 22. This may affect the combustible range of the ammonia gas relative to an excess air ratio λ, as illustrated in FIG. 7.

In FIG. 7, the combustion amount of the ammonia gas is proportional to the flow rate of the ammonia gas. The excess air ratio λ corresponds to the composition of the mixed gas formed of ammonia gas and air. When the excess air ratio is λ=1, the mixed gas is a stoichiometric mixture (stoichiometric air-fuel ratio at which the fuel is completely combusted). When the excess air ratio is λ>1, the mixed gas is a lean mixture (where the air is in excess). When the excess air ratio is λ<1, the mixed gas is a rich mixture (where the fuel is in excess).

According to the present embodiment, the gas introduction pipe 21 has the cross-sectional area S that is defined so that the mixed gas of the ammonia gas and the air flows to the combustion pipe 20 through the gas outlet 21b at an inrush flow velocity of 3 m/s to 25 m/s relative to a flow rate of the mixed gas. This widens the combustible range of the ammonia gas to the lean mixture side as a whole as indicated by the solid lines P1 and P2 in FIG. 7, compared to a case where the cross-sectional area S of the gas introduction pipe 21 does not satisfy the above-mentioned condition (see the broken lines Q1 and Q2). The solid line P1 and the broken line Q1 indicate the combustion limit values on the lean mixture side. The solid line P2 and the broken line Q2 indicate the combustion limit values on the rich mixture side. Accordingly, the range between the solid lines P1 and P2 and the range between the broken lines Q1 and Q2 are the combustible ranges of the ammonia gas. In this embodiment, the cross-sectional area S of the gas introduction pipe 21 is approximately 80 mm². A distance X (see FIG. 4) between the central axis of the gas introduction pipe 21 and the closure wall 23 is 10 mm to 100 mm.

Accordingly, in the present embodiment, the combustible range of the ammonia gas relative to the excess air ratio λ is widened, so that the ammonia gas stably and easily burns. This increases the combustion performance of the combustor 4.

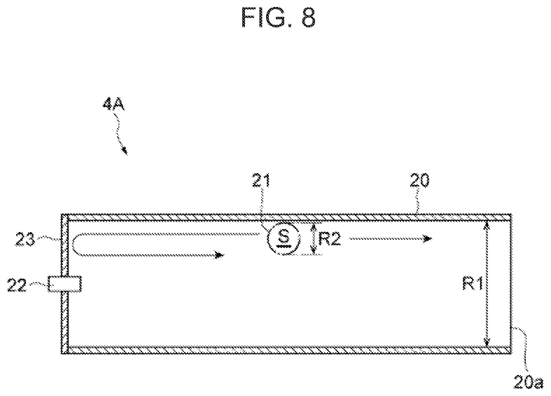

FIG. 8 is a cross-sectional view of a combustor according to a second embodiment of the present invention, and corresponds to FIG. 4. In FIG. 8, a combustor 4A according to the present embodiment includes the combustion pipe 20, the gas introduction pipe 21, and the spark plug 22, as in the first embodiment.

In the present embodiment, the ratio of an inner diameter R2 of the gas introduction pipe 21 to an inner diameter R1 of the combustion pipe 20 (the inner diameter R2 of the gas introduction pipe 21/the inner diameter R1 of the combustion pipe 20) is larger than that in the first embodiment. Specifically, the ratio of the inner diameter R2 of the gas introduction pipe 21 to the inner diameter R1 of the combustion pipe 20 is 0.30 to 0.45.

According to the present embodiment, the gas introduction pipe 21 has the cross-sectional area S that is defined so that the mixed gas of the ammonia gas and the air flows to the combustion pipe 20 through the gas outlet 21b (see FIG. 3) at the inrush flow velocity of 3 m/s to 25 m/s relative to the flow rate (L/min) of the mixed gas, as in the first embodiment.

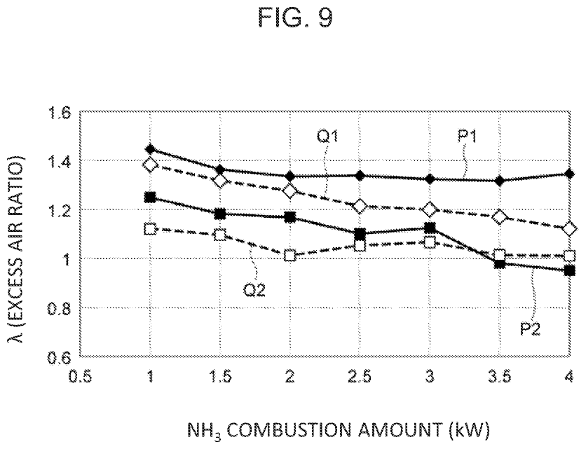

This widens the combustible range of the ammonia gas to the lean mixture side as a whole, and also widens the combustible range of the ammonia gas to the rich mixture side when the flow rate of the ammonia gas supplied to the combustion pipe 20 is particularly high as indicated by the solid lines P1 and P2 in FIG. 9, compared to a case where the ratio of the inner diameter R2 of the gas introduction pipe 21 to the inner diameter R1 of the combustion pipe 20 and the cross-sectional area S of the gas introduction pipe 21 do not satisfy the above-mentioned conditions (see the broken lines Q1 and Q2). The cross-sectional area S of the gas introduction pipe 21 and the distance X between the central axis of the gas introduction pipe 21 and the closure wall 23 (see FIG. 4) are the same as those in the first embodiment.

In the present embodiment, the combustible range of the ammonia gas relative to the excess air ratio λ is further widened when the flow rate of the ammonia gas supplied to the combustion pipe 20 is particularly high. Accordingly, the ammonia gas more stably and easily burns.

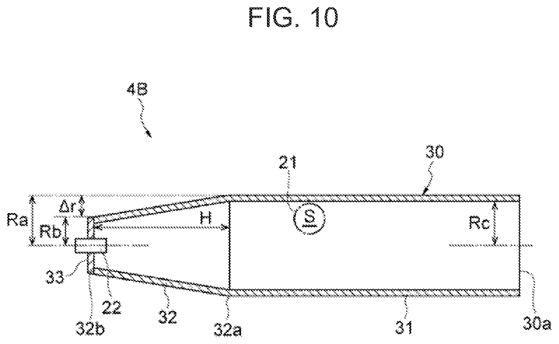

FIG. 10 is a cross-sectional view of a combustor according to a third embodiment of the present invention, and corresponds to FIG. 4. In FIG. 10, a combustor 4B according to the present embodiment includes a combustion pipe 30, the gas introduction pipe 21, and the spark plug 22.

The combustion pipe 30 has one end that is an open end 30a. The combustion pipe 30 is fixed, at the other end of the combustion pipe 30, to a closure wall 33. The combustion pipe 30 has a main body 31 that has a constant diameter along the axial direction, and a tapered portion 32 that tapers from the main body 31 toward the closure wall 33. The tapered portion 32 is located between the other end of the combustion pipe 30 and the main body 31. The main body 31 has the insertion hole 24 into which the gas introduction pipe 21 is inserted (see FIGS. 2 and 3).

A difference Δr between an outer radius Ra of a proximal end 32a of the tapered portion 32 and an outer radius Rb of a distal end 32b of the tapered portion 32 is equal to or smaller than an inner radius Rc of the main body 31. The outer radius Ra of the proximal end 32a of the tapered portion 32 is equal to the outer radius of the main body 31. The inner radius Rc of the main body 31 is the difference between the outer radius of the main body 31 and the thickness of the main body 31. The closure wall 33 is fixed to the distal end 32b of the tapered portion 32. The outer radius Rb of the distal end 32b of the tapered portion 32 is approximately equal to the radius of the closure wall 33.

The gas introduction pipe 21 has the cross-sectional area S that is defined so that the mixed gas of the ammonia gas and the air flows to the combustion pipe 30 through the gas outlet 21b (see FIG. 3) at the inrush flow velocity of 3 m/s to 25 m/s relative to the flow rate (L/min) of the mixed gas, as in the first embodiment.

In the present embodiment, the combustion pipe 30 has the tapered portion 32 that tapers from the main body 31 toward the closure wall 33. This configuration improves the symmetry of the flow velocity of the mixed gas with respect to the axial direction of the combustion pipe 30 in the vicinity of the spark plug 22. Accordingly, the ammonia gas more stably and easily burns.

In addition, in the present embodiment, the main body 31 has the insertion hole 24, and the difference Δr between the outer radius Ra of the proximal end 32a of the tapered portion 32 and the outer radius Rb of the distal end 32b of the tapered portion 32 is equal to or smaller than the inner radius Rc of the main body 31.

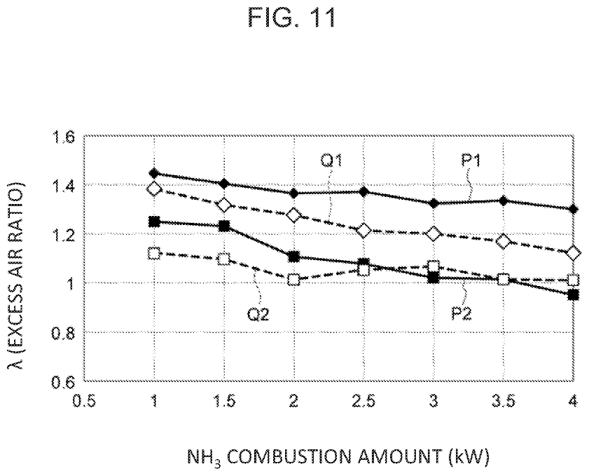

This widens the combustible range of the ammonia gas to the lean mixture side as a whole, and also widens the combustible range of the ammonia gas to the rich mixture side when the flow rate of the ammonia gas supplied to the combustion pipe 30 is particularly high as indicated by the solid lines P1 and P2 in FIG. 11, compared to a case where the combustion pipe 30 does not have the tapered portion 32 and the cross-sectional area S of the gas introduction pipe 21 does not satisfy the above-mentioned condition (see the broken lines Q1 and Q2). The cross-sectional area S of the gas introduction pipe 21 and the distance X between the central axis of the gas introduction pipe 21 and the closure wall 23 (see FIG. 4) are the same as those in the first embodiment. The difference Δr between the outer radius Ra of the proximal end 32a of the tapered portion 32 and the outer radius Rb of the distal end 32b of the tapered portion 32 is 3 mm to 10 mm, for example. A length H of the tapered portion 32 is 10 mm to 70 mm, for example. The length H of the tapered portion 32 is the length from the proximal end 32a of the tapered portion 32 to the distal end 32b of the tapered portion 32 (closure wall 33).

In the present embodiment, the combustible range of the ammonia gas relative to the excess air ratio λ is further widened when the flow rate of the ammonia gas supplied to the combustion pipe 30 is particularly high. Accordingly, the ammonia gas further stably and easily burns.

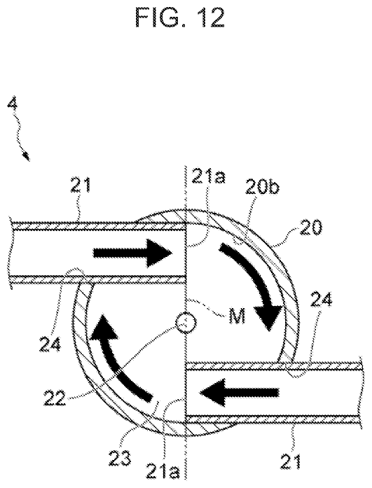

The present invention is not limited to the above-mentioned embodiments. For example, a single gas introduction pipe 21 is attached to the combustion pipe 20 or the combustion pipe 30 in the above-mentioned embodiments, but the number of the gas introduction pipes 21 is not particularly limited to one, and a plurality of the gas introduction pipes 21 may be provided. For example, two gas introduction pipes 21 may be attached to the combustion pipe 20, as illustrated in FIG. 12. In this configuration, the combustion pipe 20 has two insertion holes 24 that are spaced from each other at 180 degrees in the circumferential direction. Each of the gas introduction pipes 21 protrudes toward the inside of the combustion pipe 20 through the corresponding insertion hole 24 in the tangential direction to the inner peripheral surface 20b of the combustion pipe 20 so that the gas outlet 21a is accommodated in the combustion pipe 20.

Further, in the above-mentioned embodiments, the gas introduction pipe 21 has a cylindrical shape (circular shape in cross-section), but the shape is not particularly limited thereto. For example, in the first embodiment and the third embodiment, the gas introduction pipe 21 may have a rectangular tubular shape (quadrangular shape in cross-section) or the like.

In the above-mentioned embodiments, the closure walls 23, 33 are fixed to the other ends (ends opposite to the open ends) of the combustion pipes 20, 30, but may be fixed near the other ends of the combustion pipes 20, 30. That is, the closure walls 23, 33 simply need to be fixed on the other ends of the combustion pipes 20, 30 side.

Further, although the combustors 4, 4A, 4B of the above-mentioned embodiments are provided in the reforming system 1, the present invention is applicable to systems other than the reforming system.

Ammonia gas is used as fuel gas in the above-mentioned embodiments, but the present invention is applicable to a combustor that uses gas, such as hydrocarbon gas, as fuel gas.

Air is used as oxidized gas in the above-mentioned embodiments, but the present invention is applicable to a combustor that uses oxygen as oxidized gas.

### REFERENCE SIGNS LIST

4, 4A, 4B Combustor
20 Combustion pipe
20b Inner peripheral surface
21 Gas introduction pipe
21a Gas outlet
22 Spark plug (igniter)
23 Closure wall
24 Insertion hole
30 Combustion pipe
31 Main body
32 Tapered portion
32a Proximal end
32b Distal end
33 Closure wall
S Cross-sectional area
R1, R2 Inner diameter
Ra, Rb Outer radius
Rc Inner radius
Δr Difference

1-5. (canceled)

6. A combustor comprising:
a combustion pipe having a cylindrical shape, the combustion pipe being opened at one end of the combustion pipe and fixed to a closure wall at the other end of the combustion pipe;
a gas introduction pipe attached to the combustion pipe and introducing ammonia and oxidized gas to the combustion pipe; and
an igniter attached to the closure wall and configured to ignite the ammonia introduced by the gas introduction pipe to the combustion pipe, wherein
the combustion pipe has an insertion hole into which the gas introduction pipe is inserted,
the gas introduction pipe is connected at one end of the gas introduction pipe to the combustion pipe, and the one end has a gas outlet through which the ammonia and the oxidized gas flow to the combustion pipe,
the gas introduction pipe protrudes toward an inside of the combustion pipe through the insertion hole in a tangential direction to an inner peripheral surface of the combustion pipe so that the gas outlet is accommodated in the combustion pipe, and
the gas introduction pipe has a cross-sectional area that is defined so that mixed gas of the ammonia and the oxidized gas flows to the combustion pipe through the gas outlet at a flow velocity of 3 m/s to 25 m/s relative to a flow rate of the mixed gas.

7. The combustor according to claim 6, wherein
the gas introduction pipe has a circular shape in cross-section, and
a ratio of an inner diameter of the gas introduction pipe to an inner diameter of the combustion pipe is 0.30 to 0.45.

8. The combustor according to claim 6, wherein the combustion pipe has a main body and a tapered portion that tapers from the main body toward the closure wall.

9. The combustor according to claim 8, wherein
the main body has the insertion hole, and
a difference between an outer radius of a proximal end of the tapered portion and an outer radius of a distal end of the tapered portion is equal to or smaller than an inner radius of the main body.
